(19) United States
(12) Patent Application Publication
(10) Pub. No.: US 2017/0040014 A1
(43) Pub. Date: Feb. 9, 2017

(54) Acoustic Noise Attenuation Device, Assembly And Metamaterial Structure

(71) Applicant: Alcatel-Lucent USA Inc., Murray Hill, NJ (US)

(72) Inventors: Maria E. Simon, New Providence, NJ (US); Todd R. Salamon, New Providence, NJ (US); Young-Kai Chen, Berkeley Heights, NJ (US)

(73) Assignee: Alcatel-Lucent USA Inc., Murray Hill, NJ (US)

(21) Appl. No.: 14/820,602

(22) Filed: Aug. 7, 2015

(51) Int. Cl. G10K 11/178

(52) U.S. Cl. CPC G10K 11/178; G10K 2210/109

(57) ABSTRACT

An acoustic noise attenuator is disclosed comprising a movable body, an energy storage element and an electrical energy dissipater. The movable body is configured to oscillate when a mechanical disturbance caused by a sound wave, such as acoustic noise, is incident thereon. The oscillation of the movable body induces an alternating electrical energy in the energy storage element. The electrical energy dissipater dissipates the induced electrical energy in the form of heat. An acoustic noise attenuator assembly and a metamaterial structure comprising such acoustic noise attenuators are also disclosed.

### TECHNICAL FIELD

The present disclosure is directed, in general, to a technique for attenuating acoustic noise.

### BACKGROUND

This section introduces aspects that may help facilitate a better understanding of the disclosure. Accordingly, the statements of this section are to be read in this light and are not to be understood as admissions about what is in the prior art or what is not in the prior art.

Equipment using electronic or photonic components experience generation of heat by such components during their operation. In particular, in case of telecommunication equipment, the demand for increasing in speed and functionalities of services gives rise to higher levels of generated heat as compared to the equipment of previous generations.

In certain equipment, such as telecoms equipment, shelves, racks, cabinets or any housing containing heat generating components typically adopt trays of fans for active cooling. However, as the cooling requirements are increased due to the generation of higher amounts of heat, fan rotational speeds would need to be increased. This typically leads to a rise in acoustic noise levels such that the higher the fan rotational speed is, the higher the generated noise will be.

### SUMMARY

Some embodiments feature an apparatus, An apparatus, comprising:
a movable body;
an energy storage element; and
an electrical energy dissipater;
wherein the movable body comprises, at least partially, an electrically conductive material and is configured to oscillate in response to receiving a mechanical disturbance caused by a sound wave, the oscillation of the movable body inducing an alternating electrical energy in the energy storage element; and
wherein the electrical energy dissipater is configured to dissipate the induced electrical energy in the form of heat.

Some embodiments feature an acoustic noise attenuator assembly comprising an array of apparatus wherein each apparatus includes:
a movable body;
an energy storage element; and
an electrical energy dissipater;
wherein the movable body comprises, at least partially, an electrically conductive material and is configured to oscillate in response to receiving a mechanical disturbance caused by a sound wave, the oscillation of the movable body inducing an alternating electrical energy in the energy storage element; and
wherein the electrical energy dissipater is configured to dissipate the induced electrical energy in the form of heat.

According to some specific embodiments, the array of apparatus comprises a first apparatus having a resonant frequency equal to a first noise frequency and a second apparatus having a resonant frequency equal to a second noise frequency.

Some embodiments feature a metamaterial structure, comprising: an array of apparatus wherein each apparatus includes:
a movable body;
an energy storage element; and
an electrical energy dissipater;
wherein the movable body comprises, at least partially, an electrically conductive material and is configured to oscillate in response to receiving a mechanical disturbance caused by a sound wave, the oscillation of the movable body inducing an alternating electrical energy in the energy storage element; and
wherein the electrical energy dissipater is configured to dissipate the induced electrical energy in the form of heat.

### BRIEF DESCRIPTION OF THE DRAWINGS

FIG. 1 is an exemplary schematic representation of an apparatus for attenuating acoustic noise, according to some embodiments of the disclosure.

FIGS. 2A and 2B illustrate two different instances of operation of the apparatus of FIG. 1.

FIG. 3 is an exemplary schematic representation of an apparatus for attenuating acoustic noise, according to some embodiments of the disclosure.

FIG. 4 is an exemplary schematic representation of a metamaterial structure having a plurality of apparatus for attenuating acoustic noise arranged in an array, according to some embodiments of the disclosure.

### DETAILED DESCRIPTION OF ILLUSTRATIVE EMBODIMENTS

The common approaches to attenuate noise are typically classified under two categories: active and passive.

Active noise control systems comprise the use of powered devices. One example involves the use of microphones for measuring the level of sound, speakers to emit cancelling sound waves and a feedback control loop to manage the sound input and outputs from the microphone and speaker. These systems typically have few deployments in cabinets as they are expensive, require a high level of computational processing, and can currently only reduce sound levels in very discrete points in space. They also introduce a risk of amplifying sound power levels in other locations in space which are not being monitored by microphones

Passive noise control solutions include the use of unpowered elements. For example foams (very common) which are typically inserted in regions between individual fans in a fan tray or in regions of the cabinet architecture. Although this solution is low cost, it is typically limited in performance and requires space for installation.

Another known technique for passively reducing acoustic noise is based on the use of metamaterials.

It is known that the sound transmission through a media is inversely proportional to the media thickness, mass density and sound frequency. Sound attenuation at low frequencies (e.g., below 2000 Hz) typically requires high mass densities and/or thick materials. For example, the usage of standard materials (i.e. non-metamaterials) is limited for many applications in which one may need thicknesses on the order of the wavelength of sound, which for low frequencies can be on the order of several feet (i.e. in the range between 30 to 200 centimeters).

Engineered acoustic metamaterials do not follow the same behavior that standard materials do. These materials are typically made of unit cells (i.e. microscopic structures, holes or inclusions in a matrix) arranged in a periodic structure (lattice).

Many acoustic metamaterials having different structures are known. For example a two-dimensional array of frames containing heavy plates mounted on a thin elastic membrane was shown to be able to attenuate low frequency sound, e.g. Z. Yang, et al, “Acoustic Metamaterial Panels For Sound Attenuation In The 50-1000 Hz Regime”, 2010 American Institute of Physics, Applied Physics Letters 96, 041906 (2010), pages 0141906-1 to 3, the content of which is incorporated herein by reference in its entirety.

Other alternative structures have also been proposed, such as for example arrays of Helmholtz resonators (a cavity with a neck), e.g. L. FOK, et al, “Acoustic Metamaterials”, MRS Bulletin, October 2008, vol 33, pages 931-934; and arrays of heavy beads (e.g. lead) coated with a soft material (e.g. silicone rubber) and immersed in a matrix (e.g. epoxy), e.g. M-H Lu, et al. “Photonic Crystals And Acoustic Metamaterials”, Materialstoday, December 2009, vol 12, number 12, pages 34-42. The contents of both references are incorporated herein by reference in their entirety. In the latter document reference is made to investigation on the formation of band structures in phononic crystals and comparisons made with other waves. According to this document, while the electrons in a semiconductor can only occupy certain energy bands, a phononic crystal allows acoustic waves in specific frequency ranges to travel through via the pass band and other frequencies are inhibited by the band gap. The document concludes that this property offers a very precise means to control and manipulate phonons, sound, and other waves.

This could imply that a structure with an acoustic local resonant mode that lies inside the low energy ranges within an acoustic band structure can typically produce a band gap at that frequency. The corresponding wave vector (q=π/λ) is smaller, even much smaller, than the border zone lattice wave vector (K=π/a) as the wavelength λ is larger than the lattice constant a.

This property makes it possible to employ metamaterials in control mechanisms over wave propagation at sub-wavelength scales which is particularly useful for acoustic noise attenuation at low frequencies (up to few KHz) where the wavelengths are relatively large (in the range of few tens of cm in air).

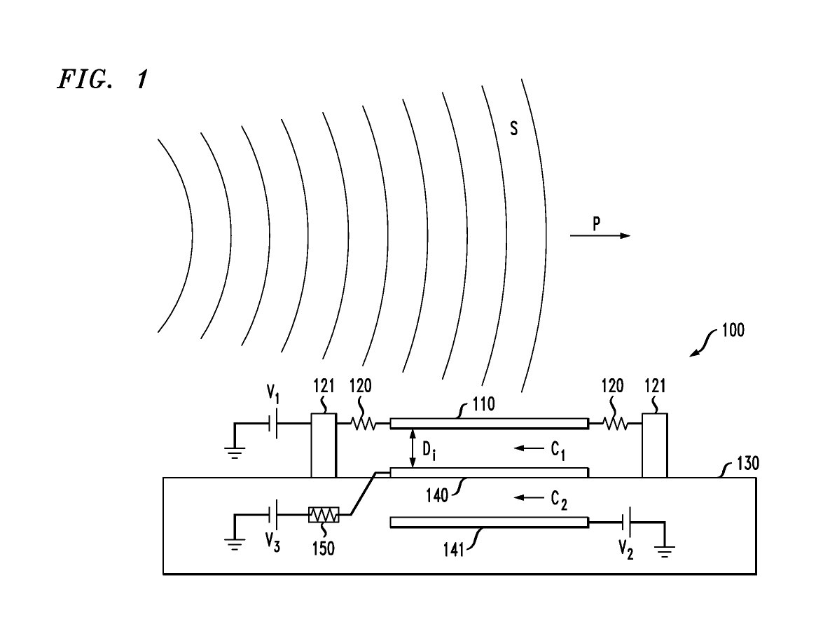

FIG. 1 illustrates an apparatus which represents an exemplary acoustic noise attenuator 100 according to some embodiments of the disclosure. The acoustic noise attenuator 100 comprises a movable body 110 attached to a flexible support element 120. The movable body may be of any convenient shape, for example a generally flat shape as shown in FIG. 1. The movable body may be made of any standard rigid or flexible material suitable for the intended use described further below.

The flexible support element 120 may be provided using any known technique, for example by using one or more springs, as shown in FIG. 1 and may be configured to flexibly support the movable body both in movement and in rest (i.e. motionless state). The flexible support element 120 may be mounted on a sustainment structure 121 which in turn is mounted on a substrate 130. Sustainment structure 121 and substrate 130 may be made of any material and in any shape which are suitable for the intended purpose.

The movable body 110 may be made of a material which in its totality is electrically conductive or of one which comprises at least partially an electrically conductive part. In the example shown in FIG. 1 it is assumed that the movable body is in its totality is electrically conductive, such as a metal.

The apparatus further comprises a first fixed electric conductor 140 which is, in turn, electrically connected to an electrical energy dissipater 150 as shown in FIG. 1. In one example, the electrical energy dissipater is a resistor 150.

As can be seen in FIG. 1, the movable body 110 and the first electric conductor 140 form a capacitor C1 (as mentioned above the movable body has at least partially an electrically conductive part). Therefore, each of the movable body 110 and the first electric conductor 140 is capable of acting as an electrode of the capacitor.

In a rest situation (i.e., no mechanical disturbance acting on the movable body), the movable body 110 and the first electric conductor 140 are at an initial distance Dᵢ from each other.

With the above configuration, the acoustic noise attenuator 100 may be installed inside a cabinet, rack, or similar housing which includes fans or other acoustic noise generating sources. The acoustic noise attenuator 100 is preferably installed at a location where the movable body 110 is placed in or adjacent to the propagation path of the sound waves S as shown in FIG. 1. This may cause the movable body 110 to oscillate in response to the mechanical disturbances caused by the effect of the propagation of the sound waves S on the movable body 110.

A first voltage source V1 is, at one terminal thereof, electrically connected to the capacitor C1, and at another terminal is connected to the ground or another voltage source. The first voltage source V1 is configured to apply a voltage to the capacitor C1 causing electric charge to accumulate on the movable body 110 and electric charge of an opposite sign on the first electric conductor 140.

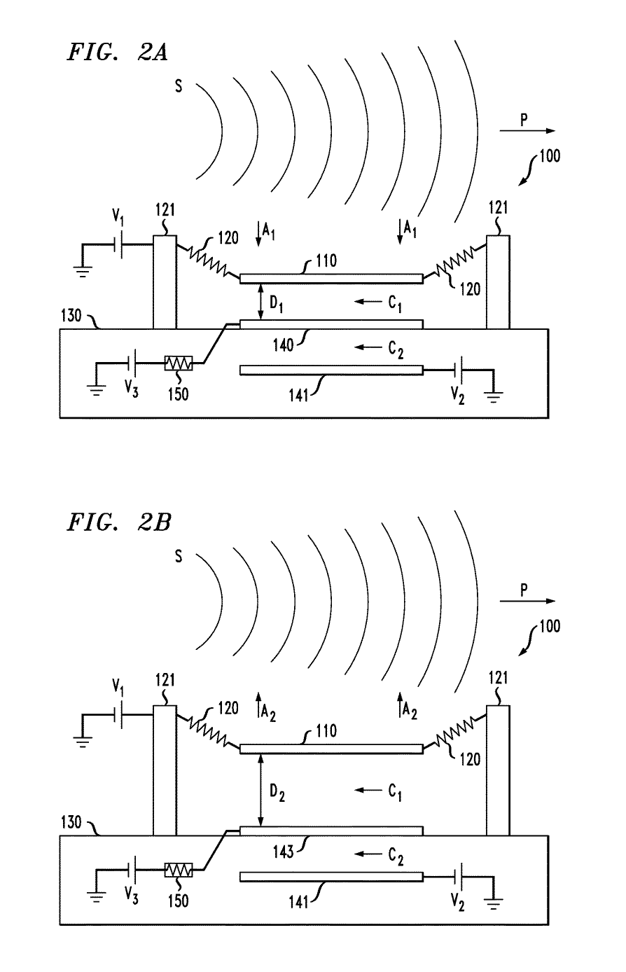

The principles of operation of the acoustic noise attenuator 100 will now be described with reference to FIGS. 2A and 2B. Like elements in FIGS. 2A and 2B have been provided with like reference numerals as those of FIG. 1.

Referring first to FIG. 2A, the acoustic noise attenuator 100 is shown, in a first instance, to receive sound waves (e.g. acoustic noise) S as the latter propagate from a source of acoustic noise (not explicitly shown) such as a fan. The direction of propagation of the sound waves S is shown by arrow P.

The propagation of sound waves S imposes a mechanical disturbance on the movable body 110. It is assumed, in this example, that the flexible support elements 120 are springs. In the first instance, the mechanical disturbance may cause the movable body 110 to be displaced in a first direction, e.g. downward in FIG. 2A as shown by arrows A1. This movement causes the springs 120 to flexibly stretch and follow the movement of the movable body 110 as they support it.

For example as shown in FIG. 2A, during the first instance of movement, the movable body 110 moves closer to the first electric conductor 140 such that the distance between the two is reduced to D₁, i.e. D₁<Dᵢ.

As it is well know, the capacitance of a capacitor is inversely proportional to the distance between its electrodes. As a consequence, the capacitance of the capacitor C1 changes as the movable body 110 moves in the first direction. In the example of FIG. 2A, movement of the movable body in the direction of arrows A causes the capacitance of capacitor C1 to increase.

However, as the springs 120 are at the same time stretched (extended) by the movement of the movable body 110, they exert a reactive opposing force on the movable body 110 to return the latter back to its rest position.

FIG. 2B is schematic representation of the acoustic noise attenuator 100 in a second instance, illustrating the return action of the movable body 110 caused by the reaction force exerted on it by the springs 120.

In the second instance, the return movement of the movable body 110 is in a second direction which causes the latter to move away from the first electric conductor 140. The second direction is represented in FIG. 2B as A2 which is a direction opposite to the direction of movement A1 during the first instance. Therefore, as shown in FIG. 2B, during the second instance of movement, the distance between the movable body and the first electric conductor 140 is increased to D₂, i.e. D_{2>}Dᵢ. As a consequence, the capacitance of the capacitor C1 changes as the movable body 110 moves in the second direction. In the example of FIG. 2B, movement of the movable body in the direction of arrows A2 causes the capacitance of capacitor C1 to decrease.

Here also, as the springs 120 are at the same time stretched (extended) by the movement of the movable body 110, they exert a reactive opposing force on the movable body 110 to return the latter back to its rest position. Upon returning to rest position, a new cycle of movement in the two directions described above starts (assuming that sound waves continue propagating).

The movement of the movable body 110 in the two opposite directions, as described above, constitutes an oscillation movement. This oscillation of the moveable body, in response to the effect of sound waves S, changes the capacitance of capacitor C1 and thereby induces oscillations of the charge stored in the first electric conductor 140. The oscillating charge in the first electric conductor 140 generates an alternating current which then flows to ground through the resistor 150 in which energy is dissipated in the form of heat.

It is noted that this dissipated energy is in fact a portion of the energy present in the sound waves S. In particular, mechanical energy provided by the sound waves S are first converted into electrical energy and the electrical energy is then converted into thermal energy, i.e. heat which is then dissipated. As a consequence, the acoustic noise attenuator 100 is capable of dissipating at least a portion of the acoustic noise.

In this manner, the sound waves undergo attenuation provided by the oscillation of the movable body 110 and the combined effect of the capacitor C1 and the resistor 150 as described above.

The oscillation frequency of the movable body 110, may be changed by varying the the stiffness of the flexible support structures 120 or the mass of the movable body 110, among other possibilities.

As the first electric conductor 140 may accumulate charges during operation and these charges may give rise to parasitic capacitance with respect to the environment, the apparatus may preferably comprise a second capacitor formed between the first fixed electric conductor 140 and a second fixed electric conductor 141. The first and the second fixed electric conductors, 140 and 141, would therefore form the two electrodes of the second capacitor C2.

Preferably a second voltage source V2 may be connected between the second fixed electric conductor 141 and ground. This second voltage source V2 may be used to provide charge equilibrium between the first and the second capacitors C1 and C2 as will be described below.

Assuming Q1 to be the magnitude of charge available on the first capacitor C1 (positive on one electrode and negative on the other) and Q2 to be the magnitude of charge available on the second capacitor C2 (positive on one electrode and negative on the other), then for an equilibrium to exist these two charges would need to be equal and of opposite sign, that is:

Q1=−Q2

As charge on a capacitor may generally be expressed as Q=CV, where C is the capacitance and V is the voltage applied on the electrodes of the capacitor, then it may be concluded that for an equilibrium to be established, the following relationship should hold:

V1·c1=−V2·c2

where c1 is the capacitance of the first capacitor at rest (without moving) and c2 is the capacitance of the second capacitor.

The above condition equilibrium holds as long as the first capacitor C1 does not undergo a change due to the movement of the movable body 110. However, once the movable body starts to oscillate (e.g. up and down in FIG. 1) the capacitance c1 of the first capacitor C1 will change and therefore the accumulation of charges on the first and second electric conductors 140, 141 will vary accordingly in an alternating fashion. Such alternating variation in charge generates an alternating current which passes through the resistor 150. As a result, resistor 150 generates heat which is dissipated in the ambient surroundings.

Preferably a third voltage source V3 is connected between the resistor 150 and ground. This third voltage source V3 may be used to provide for adjustment purposes.

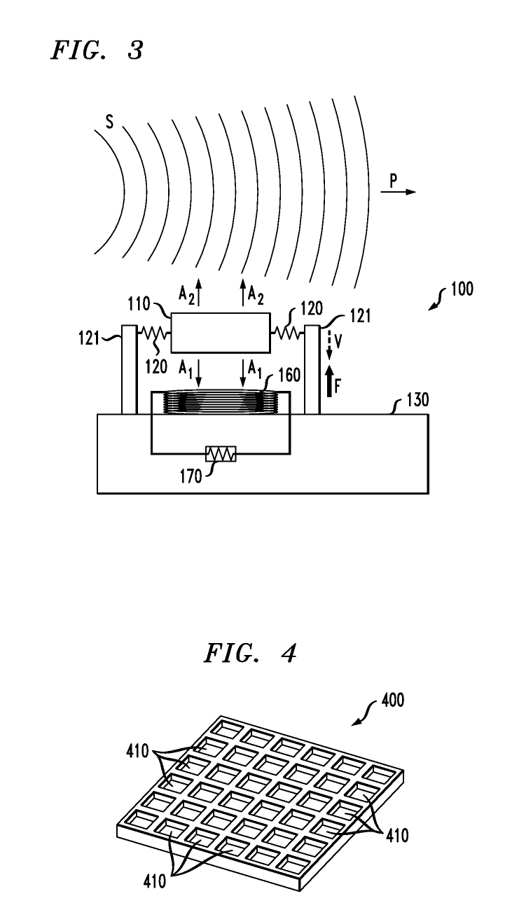

FIG. 3 illustrates an exemplary acoustic noise attenuator 100 according to some embodiments of the disclosure. Unless otherwise provided, like elements in FIG. 3 have been provided with like reference numerals as those of FIG. 1.

Referring to FIG. 3, the acoustic noise attenuator 100 comprises a movable body 110 attached to a flexible support element 120. The flexible support element 120 may be made using any known technique, for example by using one or more springs, as shown in FIG. 3, configured to flexibly support the movable body 110 both in movement and in rest (i.e. motionless state). The flexible support element 120 may be mounted on a sustainment structure 121 which in turn is mounted on a substrate 130. Sustainment structure 121 and substrate 130 may be made of any material and in any shape which are suitable for the intended purpose

The movable body 110 comprises a magnetic element. In some embodiments, the movable body may be entirely made of permanent magnet. In some embodiments, the movable body may comprise an electromagnet (e.g. a coil provided with a direct current or voltage source). In the example of FIG. 3 it is assumed that the movable body comprises a permanent magnet (which for simplicity will also be referred to as magnet).

The acoustic noise attenuator 100 further comprises an electromagnetic inductor 160. The inductor 160 may be in the form of an electromagnetic coil. The inductor 160 may be electrically connected to an electrical energy dissipater 170 to thereby form a closed electric circuit therewith. In the example of FIG. 3 the electrical energy dissipater 170 is a resistor.

In operation, the acoustic noise attenuator 100 receives sound waves (i.e. acoustic noise) S as the latter propagate from a source of acoustic noise (not explicitly shown). The direction of propagation of the sound waves S is shown by arrow P.

Similar to the embodiment of FIGS. 2A and 2B, the propagation of sound waves S imposes a mechanical disturbance on the movable body 110 causing the movable body 100 to oscillate, as shown in the example of FIG. 3 by arrows A1 and A2.

As the movable body 110 comprises a magnetic element, a current is induced in the inductor 160 which imposes, in turn, a force F on the movable body 110, the force F being proportional in magnitude to the oscillation velocity V of the movable body 110 but with opposite sign. This induced force F provides a damping force on the movable body, in addition to the damping force caused by air friction and internal friction on the springs.

Therefore, the mechanical oscillations of the movable body in the direction of arrows A1 and A2 induce an alternating electrical current in the inductor 160. The induced current then flows through resistor 170 where it is dissipated as heat, similar to the embodiment of FIGS. 2A and 2B.

Similar to the embodiments of FIGS. 1, 2A and 2B, here also the dissipated energy is a portion of the mechanical energy present in the sound waves S which is first converted into electrical energy and the electrical energy is then converted into thermal energy, i.e. heat which is then dissipated. As a consequence, the acoustic noise attenuator 100 is capable of dissipating at least a portion of the acoustic noise.

In this manner, the sound waves, undergo attenuation provided by the oscillation of the of the movable body 110 and the combined effect of the inductor 160 and the resistor 170 as described above.

The oscillation frequency of the movable body 110 in the embodiment of FIG. 3 may be changed by varying the stiffness of the flexible support structures 120 or the mass of the movable body 110 among other possibilities.

In the embodiments described above, the voltages V1, V2 and V3 may be provided and applied using known techniques.

It is to be noted that an assembly of noise attenuators 100 as described in the above embodiments, may be provided in an array comprising a plurality of individual acoustic noise attenuators.

In some embodiments, the plurality of individual acoustic noise attenuators in the array may each have resonant frequencies equal to a specific noise frequency. This embodiment is particularly useful in cases where noise is generated in a certain frequency or a certain small frequency band.

In some embodiments, the plurality of individual acoustic noise attenuators in the array may comprise one or more acoustic noise attenuator having a resonant frequency equal to a first noise frequency one or more acoustic noise attenuator having a resonant frequency equal to a second noise frequency. This embodiment is particularly useful in cases where it is intended to attenuate a range of frequencies rather than only one specific frequency.

In some embodiments, the acoustic noise attenuator may be made using discrete standard sized elements, or using micro-electromechanical systems (MEMS). In particular the movable body 100, the support elements 120, the sustainment structures 121 and the substrate may all or some be comprised in a MEMS structure.

In case the acoustic noise attenuators 100 are made in small size, e.g. MEMS, a metamaterial structure may be made using a plurality of such attenuators. In this regard, a unit cell forming a metamaterial structure may have a complex structure with some local resonant mode. The resonant mode can hybridize with the bands given by the lattice modifying the bands to thereby create a structure with unconventional properties. An acoustic noise attenuator made according to the above embodiments may be used as a unite cell for such metamaterial structure.

FIG. 4 shows a simplified example of an array 400 of acoustic noise attenuators 410 which in their assembly form a metamaterial structure. Each individual acoustic noise attenuator may then be considered as a unit cell (as referred to in metamaterials) having local resonant modes based on the resonance characteristics of the individual acoustic noise attenuators 410.

Arranging the acoustic noise attenuators in an array enables flexibility in the design of noise attenuator assemblies in conformity with any specific shape, volume and space requirements within the environment where noise attenuation is sought. For example the array 400 may comprise acoustic noise attenuators (as unit cells) having different resonant frequencies. This would enable the array to provide resonance at the various frequencies of sound which is, as mentioned previously, advantageous as it allows the array 400 to cover a range of frequencies for noise attenuation rather than only one frequency.

The apparatus, the acoustic noise attenuator assembly and the metamaterial structure as disclosed herein may be configured to attenuate any convenient frequency range of acoustic noise. Some non-limiting examples of frequency of such sound waves may be frequencies up to 2000 Hz approximately, among which a range between 20 Hz and 1000 Hz may be a preferred range.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

What is claimed is:

1. An apparatus, comprising:
a movable body;
an energy storage element; and
an electrical energy dissipater;
wherein the movable body comprises, at least partially, an electrically conductive material and is configured to oscillate in response to receiving a mechanical disturbance caused by a sound wave, the oscillation of the movable body inducing an alternating electrical energy in the energy storage element; and
wherein the electrical energy dissipater is configured to dissipate the induced electrical energy in the form of heat.

2. The apparatus of claim 1, further comprising a first fixed electric conductor wherein the movable body and the first fixed electric conductor form a capacitor such that an oscillation of the movable body reduces or increases distance relative to the first fixed electric conductor to thereby change a capacitance of the first capacitor.

3. The apparatus of claim 2, wherein apparatus further comprises a first voltage source configured to apply a voltage to the first capacitor to cause electric charges of opposite signs to collect on the movable body and the first fixed electric conductor respectively.

4. The apparatus of claim 2, further comprising:
a second fixed electric conductor, such that the first and the second fixed electric conductors are configured to form a second capacitor; and
a second voltage source electrically connected between the second fixed electric conductor and ground and configured to provide charge equilibrium between the first capacitor and the second capacitor.

5. The apparatus of claim 4, wherein the electrical energy dissipater is electrically connected at one terminal thereof to the first fixed electric conductor and at another terminal thereof to a third voltage source.

6. The apparatus of claim 1, wherein the movable body comprises a magnetic element and the energy storage element is an inductor, the movable body being configured to oscillate relative to the inductor, being fixed in place, such that the oscillation of the movable body induces an alternating current in the inductor.

7. The apparatus of claim 6, wherein the inductor is configured to generate a force in response to the oscillation of the magnetic element comprised in the movable body, said force being proportional in magnitude to the oscillation velocity of the movable body, with opposite sign.

8. The apparatus of claim 6, wherein the magnetic element is a permanent magnet or an electromagnet.

9. The apparatus of claim 6, wherein the inductor is connected in parallel to the electrical energy dissipater.

10. The apparatus of claim 1, wherein the movable body is attached to one or more flexible support elements, each flexible support element configured to flexibly support the oscillation of the movable body.

11. The apparatus of claim 1, wherein the acoustic noise attenuator comprises a micro-electromechanical system.

12. The apparatus of claim 1, wherein said sound waves have frequencies less than or equal to 2000 Hz.

13. The apparatus of claim 12, wherein the frequency of the sound waves is in a range between 20 Hz and 1000 Hz.

14. An acoustic noise attenuator assembly comprising an array of apparatus wherein each apparatus includes:
a movable body;
an energy storage element; and
an electrical energy dissipater;
wherein the movable body comprises, at least partially, an electrically conductive material and is configured to oscillate in response to receiving a mechanical disturbance caused by a sound wave, the oscillation of the movable body inducing an alternating electrical energy in the energy storage element; and
wherein the electrical energy dissipater is configured to dissipate the induced electrical energy in the form of heat.

15. The apparatus of claim 14, wherein the array of apparatus comprises a first apparatus having a resonant frequency equal to a first noise frequency and a second apparatus having a resonant frequency equal to a second noise frequency.

16. A metamaterial structure, comprising:
an array of apparatus, each apparatus including:
a movable body;
an energy storage element; and
an electrical energy dissipater;
wherein the movable body comprises, at least partially, an electrically conductive material and is configured to oscillate in response to receiving a mechanical disturbance caused by a sound wave, the oscillation of the movable body inducing an alternating electrical energy in the energy storage element; and
wherein the electrical energy dissipater is configured to dissipate the induced electrical energy in the form of heat.

17. The apparatus of claim 16, wherein the metamaterial structure comprises a first apparatus having a resonant frequency equal to a first noise frequency and a second apparatus having a resonant frequency equal to a second noise frequency.
